(19) United States
(12) Patent Application Publication
(10) Pub. No.: US 2022/0255063 A1
(43) Pub. Date: Aug. 11, 2022

(54) LITHIUM-CONTAINING ELECTRODES INCLUDING CERAMIC PARTICLES AND METHODS OF MAKING THE SAME

(71) Applicant: GM GLOBAL TECHNOLOGY OPERATIONS LLC, Detroit, MI (US)

(72) Inventors: Thomas A. YERSAK, Royal Oak, MI (US); Fan XU, Oakland Township, MI (US); Robert D. SCHMIDT, Howell, MI (US); Biqiong WANG, Madison Heights, MI (US); James R. SALVADOR, East Lansing, MI (US)

(73) Assignee: GM GLOBAL TECHNOLOGY OPERATIONS LLC, Detroit, MI (US)

(21) Appl. No.: 17/172,286

(22) Filed: Feb. 10, 2021

(51) Int. Cl. H01M 4/36; H01M 4/38; H01M 10/0562; H01M 4/62; H01M 10/052

(52) U.S. Cl. CPC H01M 4/366; H01M 4/382; H01M 10/0562; H01M 2004/021; H01M 10/052; H01M 2300/0071; H01M 4/62

(57) ABSTRACT

A lithium metal electrode including ceramic particles is provided herein as well as electrochemical cells including the lithium metal electrode and methods of making the lithium metal electrode. The lithium metal electrode includes ceramic particles present as a ceramic layer adjacent to a first surface of the lithium metal electrode, embedded within the first surface, or a combination thereof. The ceramic particles include lithium lanthanum zirconium oxide (LLZO) particles, alumina particles, or a combination thereof.

### FIELD

The present disclosure relates to lithium metal electrodes including ceramic particles, for example, present as a ceramic layer, electrochemical cells including the lithium metal electrodes, and methods for making the lithium metal electrodes with ceramic particles.

### BACKGROUND

This section provides background information related to the present disclosure which is not necessarily prior art.

High-energy density, electrochemical cells, such as lithium ion batteries can be used in a variety of consumer products and vehicles, such as Hybrid Electric Vehicles (HEVs) and Electric Vehicles (EVs). Typical lithium ion batteries comprise a first electrode (e.g., a cathode), a second electrode of opposite polarity (e.g., an anode), an electrolyte material, and a separator. Conventional lithium ion batteries operate by reversibly passing lithium ions between the negative electrode and the positive electrode. A separator and an electrolyte are disposed between the negative and positive electrodes. The electrolyte is suitable for conducting lithium ions and may be in solid, semi-solid or liquid form. Lithium ions move from a cathode (positive electrode) to an anode (negative electrode) during charging of the battery, and in the opposite direction when discharging the battery. For convenience, a negative electrode will be used synonymously with an anode, although as recognized by those of skill in the art, during certain phases of lithium ion cycling the anode function may be associated with the positive electrode rather than negative electrode (e.g., the negative electrode may be an anode on discharge and a cathode on charge).

In various aspects, an electrode includes an electroactive material. Negative electrodes typically comprise such an electroactive material that is capable of functioning as a lithium host material serving as a negative terminal of a lithium ion battery. Conventional negative electrodes include the electroactive lithium host material and optionally another electrically conductive material, such as carbon black particles, as well as one or more polymeric binder materials to hold the lithium host material and electrically conductive particles together.

Lithium ion batteries can reversibly supply power to an associated load device on demand. More specifically, electrical power can be supplied to a load device by a lithium ion battery until the lithium content of the negative electrode is effectively depleted. The battery may then be recharged by passing a suitable direct electrical current in the opposite direction between the electrodes.

During discharge, the negative electrode may contain a relatively high concentration of intercalated lithium, which is oxidized into lithium ions and electrons. The lithium ions travel from the negative electrode (anode) to the positive electrode (cathode), for example, through the ionically conductive electrolyte solution contained within the pores of an interposed porous separator. At the same time, the electrons pass through the external circuit from the negative electrode to the positive electrode. The lithium ions may be assimilated into the material of the positive electrode by an electrochemical reduction reaction. The battery may be recharged after a partial or full discharge of its available capacity by an external power source, which reverses the electrochemical reactions that transpired during discharge.

During recharge, intercalated lithium in the positive electrode is oxidized into lithium ions and electrons. The lithium ions travel from the positive electrode to the negative electrode through the porous separator via the electrolyte, and the electrons pass through the external circuit to the negative electrode. The lithium cations are reduced to elemental lithium at the negative electrode and stored in the material of the negative electrode for reuse.

During cycling a passivation layer, also known as a solid electrolyte interphase (SEI) layer, forms on a surface of a lithium-containing negative electrode from decomposition products of the electrolyte. The SEI layer can play a role in the prevention of further electrolyte decomposition to maintain cycling ability, which requires that the SEI layer is well adhered to the negative electrode, has good ionic transport of lithium ions, is mechanically robust, and has good electronic insulation properties. However, during repeated cycling, the SEI layer on a lithium-containing negative electrode may grow thick and result in lower Coulumbic efficiency and premature cell failure, for example, due to faster electrolyte consumption.

It would be desirable to develop materials for lithium ion batteries, for use in high energy and high power lithium ion batteries, which overcome the current shortcomings that prevent their widespread commercial use. Accordingly, it would be desirable to develop materials for lithium ion batteries, particularly for lithium-containing negative electrodes, which improve the qualities of the SEI layer, for example, improve ionic transport and mechanical robustness of the SEI layer and promote smooth lithium depositions and thereby increase Coulombic efficiency, rate performance, and fast charge capability.

### SUMMARY

This section provides a general summary of the disclosure and is not a comprehensive disclosure of its full scope or all of its features.

In certain aspects, the present disclosure provides a lithium metal electrode. The lithium metal electrode includes a first surface and ceramic particles. The ceramic particles can include lithium lanthanum zirconium oxide (LLZO) particles, alumina particles, zirconia particles, or a combination thereof. The ceramic particles can be present as a ceramic layer adjacent to at least a portion of the first surface, embedded within the first surface, or a combination thereof. The ceramic layer can have a thickness of about 1 μm to about 100 μm.

The LLZO particles can be selected from the group consisting of: Li_{(7-3y)}Al_{y}La₃Zr₂O₁₂, where 0≤y≤⅔; Li_{7+x-3y-z}La₃₋ₓ(M)ₓ(N)_{y}Zr_{2-z}(Q)_{z}O₁₂, where M is Ca, Ba, Mg, or Sr; N is Al or (¾)Ge; Q is Ta or Nb; 0≤x≤1; 0≤y≤⅔; 0≤y≤⅔; 0≤z≤2; and 5≤(7+x−3y−z)≤7; or a combination. Additionally, the LLZO particles, the alumina particles, and the zirconia particles each may have an average particle diameter of about 100 nm to about 20 μm.

The LLZO particles can be present in an amount of 0.5 g/cm² to about 50 g/cm². Additionally, the alumina particles can be present in an amount of 0.4 g/cm² to about 40 g/cm². Additionally, the zirconia particles can be present in an amount of about 0.5 g/cm² to about 50 g/cm².

A binder may be present with the ceramic particles and the binder can coat at least a portion of the ceramic particles.

The ceramic particles can be present as embedded within the first surface.

The lithium metal electrode can include metallic lithium.

In yet other aspects, the present disclosure provides an electrochemical cell. The electrochemical cell includes a lithium metal negative electrode a first surface and ceramic particles. The ceramic particles can include lithium lanthanum zirconium oxide (LLZO) particles, alumina particles, zirconia particles, or a combination thereof. The ceramic particles can be present as a ceramic layer adjacent to at least a portion of the first surface, embedded within the first surface, or a combination thereof. The ceramic layer can have a thickness of about 1 μm to about 100 μm. The electrochemical cell can also include a positive electrode including a second electroactive material. The positive electrode can be spaced apart from the lithium metal negative electrode. The electrochemical cell can also include a porous separator disposed between confronting surfaces of the lithium metal negative electrode and the positive electrode, and a liquid electrolyte infiltrating one or more of the lithium metal negative electrode, the positive electrode, and the porous separator.

The LLZO particles can be selected from the group consisting of: Li_{(7-3y)}Al_{y}La₃Zr₂O₁₂, where 0≤y≤⅔; Li_{7+x-3y-z}La₃₋ₓ(M)ₓ(N)_{y}Zr_{2-z}(Q)_{z}O₁₂, where M is Ca, Ba, Mg, or Sr; N is Al or (¾)Ge; Q is Ta or Nb; 0≤x≤1; 0≤y≤⅔; 0≤y≤⅔; 0≤z≤2; and 5≤(7+x−3y−z)≤7; or a combination. Additionally, the LLZO particles, the alumina particles, and the zirconia particles each may have an average particle diameter of about 100 nm to about 20 μm.

The LLZO particles can be present in an amount of 0.5 g/cm² to about 50 g/cm². Additionally, the alumina particles can be present in an amount of 0.4 g/cm² to about 40 g/cm². Additionally, the zirconia particles can be present in an amount of about 0.5 g/cm² to about 50 g/cm².

A binder may be present with the ceramic particles and the binder can coat at least a portion of the ceramic particles.

The ceramic particles can be present as embedded within the first surface.

The lithium metal electrode can include metallic lithium. The second electroactive material can include Li₍₁₊ₓ₎Mn₂O₄, where 0.1≤x≤1; LiMn₍₂₋ₓ₎NiₓO₄, where 0≤x≤0.5; LiCoO₂; Li(NiₓMn_{y}Co_{z})O₂, where 0≤x≤1, 0≤y≤1, 0≤z≤1, and x+y+z=1; LiNi_{(1-x-y)}CoₓM_{y}O₂, where 0≤x≤0.2, y≤0.2, and M is Al, Mg, or Ti; LiFePO₄, LiMn₂₋ₓFexPO₄, where 0≤x≤0.3; LiNiCoAlO₂; LiMPO₄, where M is at least one of Fe, Ni, Co, and Mn; Li(NiₓMn_{y}Co_{z}Alₚ)O₂, where 0≤x≤1, 0≤y≤1, 0≤z≤1, 0≤P≤1, x+y+z+p=1 (NCMA); LiNiMnCoO₂; Li₂FeₓM₁₋ₓPO₄, where M is Mn and/or Ni, 0≤x≤1; LiMn₂O₄; LiFeSiO₄; LiNi_{0.6}Mn_{0.2}Co_{0.2}O₂ (NMC622), LiMnO₂ (LMO), activated carbon, sulfur, and a combination thereof.

In yet other aspects, the present disclosure provides a method of preparing a lithium metal electrode. The method includes applying ceramic particles to a first surface of the lithium metal electrode to form a ceramic layer including the ceramic particles. The ceramic layer can be adjacent to at least a portion of the first surface and can have a thickness of about 1 μm to about 100 μm. The applying the ceramic particles can include dry casting or slurry casting. The ceramic particles can include lithium lanthanum zirconium oxide (LLZO) particles, alumina particles, zirconia particles, or a combination thereof.

The LLZO particles can be selected from the group consisting of: Li_{(7-3y)}Al_{y}La₃Zr₂O₁₂, where 0≤y≤⅔; Li_{7+x-3y-z}La₃₋ₓ(M)ₓ(N)_{y}Zr_{2-z}(Q)_{z}O₁₂, where M is Ca, Ba, Mg, or Sr; N is Al or (¾)Ge; Q is Ta or Nb; 0≤x≤1; 0≤y≤⅔; 0≤y≤⅔; 0≤z≤2; and 5≤(7+x−3y−z)≤7; or a combination. Additionally, the LLZO particles, the alumina particles, and the zirconia particles each may have an average particle diameter of about 100 nm to about 20 μm.

The LLZO particles can be present in an amount of 0.5 g/cm² to about 50 g/cm². Additionally, the alumina particles can be present in an amount of 0.4 g/cm² to about 40 g/cm². Additionally, the zirconia particles can be present in an amount of about 0.5 g/cm² to about 50 g/cm².

A binder can be applied with the ceramic particles and the binder can coat at least a portion of the ceramic particles.

The method can further include pressing the ceramic layer to embed the ceramic particles within the first surface.

The applying the ceramic particles can be a slurry casting can be applying a slurry to the first surface. The slurry can include a solvent and the ceramic particles.

The method may further include drying the slurry applied to the first surface of the lithium metal negative electrode to remove the solvent.

Further areas of applicability will become apparent from the description provided herein. The description and specific examples in this summary are intended for purposes of illustration only and are not intended to limit the scope of the present disclosure.

### DRAWINGS

The drawings described herein are for illustrative purposes only of selected embodiments and not all possible implementations, and are not intended to limit the scope of the present disclosure.

FIG. 1 is a schematic of an exemplary electrochemical battery cell;

FIGS. 2A-2D are schematics of exemplary lithium metal electrodes including ceramic particles;

FIG. 3 is a schematic of an exemplary battery;

FIGS. 4A-4D are exemplary schematics illustrating methods of making a lithium metal electrode with ceramic particles;

FIGS. 5A-5C. FIG. 5A is photographic image of control anode, Anode 2 and Anode 6 formed according to Example 1. FIGS. 5B and 5C are scanning electron microscopy (SEM) images of Anode 2 formed according to Example 1;

FIGS. 6A-6B. FIG. 6A is a graph depicting capacity (mAh) versus cycle number for Cells 2, 3, 5, and 6 and Control Cell A formed according to Example 2 following regular cycling conditions. FIG. 6B is a graph depicting Coulombic efficiency versus cycle number for Cells 2, 3, 5, and 6 and Control Cell A formed according to Example 2 following basic cycling conditions;

FIGS. 7A-7B. FIG. 7A is a graph depicting capacity (mAh) versus cycle number for Cells 1 and 4 and Control Cell A formed according to Example 2 following fast charge cycling conditions. FIG. 7B is a graph depicting Coulombic efficiency versus cycle number for Cells 1 and 4 and Control Cell A formed according to Example 2 following fast charge cycling conditions;

FIGS. 8A-8C. FIG. 8A is a photographic image of anodes from Control Cell A, Cell 2, Cell 3, and Cell 6 after cycling. FIGS. 8B and 8C are SEM images of the anode surface of Control Cell A and Cell 6, respectively, after basic cycling conditions;

FIGS. 9A-9B. FIG. 9A is a graph depicting capacity (mAh) versus cycle number for Cells 7 and 8 and Control Cell A formed according to Example 3 following regular cycling conditions. FIG. 9B is a graph depicting Coulombic efficiency versus cycle number for Cells 7 and 8 and Control Cell A formed according to Example 3 following regular cycling conditions; and

FIGS. 10-10B. FIG. 10A is a graph depicting capacity (mAh) versus cycle number for Cells 9 and 10 and Control Cell A formed according to Example 3 following fast charge cycling conditions. FIG. 10B is a graph depicting Coulombic efficiency versus cycle number for Cells 9 and 10 and Control Cell A formed according to Example 3 following fast charge cycling conditions.

Corresponding reference numerals indicate corresponding parts throughout the several views of the drawings.

### DETAILED DESCRIPTION

Example embodiments will now be described more fully with reference to the accompanying drawings.

Example embodiments are provided so that this disclosure will be thorough, and will fully convey the scope to those who are skilled in the art. Numerous specific details are set forth such as examples of specific compositions, components, devices, and methods, to provide a thorough understanding of embodiments of the present disclosure. It will be apparent to those skilled in the art that specific details need not be employed, that example embodiments may be embodied in many different forms and that neither should be construed to limit the scope of the disclosure. In some example embodiments, well-known processes, well-known device structures, and well-known technologies are not described in detail.

The terminology used herein is for the purpose of describing particular example embodiments only and is not intended to be limiting. As used herein, the singular forms “a,” “an,” and “the” may be intended to include the plural forms as well, unless the context clearly indicates otherwise. The terms “comprises,” “comprising,” “including,” and “having,” are inclusive and therefore specify the presence of stated features, elements, compositions, steps, integers, operations, and/or components, but do not preclude the presence or addition of one or more other features, integers, steps, operations, elements, components, and/or groups thereof. Although the open-ended term “comprising,” is to be understood as a non-restrictive term used to describe and claim various embodiments set forth herein, in certain aspects, the term may alternatively be understood to instead be a more limiting and restrictive term, such as “consisting of” or “consisting essentially of” Thus, for any given embodiment reciting compositions, materials, components, elements, features, integers, operations, and/or process steps, the present disclosure also specifically includes embodiments consisting of, or consisting essentially of, such recited compositions, materials, components, elements, features, integers, operations, and/or process steps. In the case of “consisting of,” the alternative embodiment excludes any additional compositions, materials, components, elements, features, integers, operations, and/or process steps, while in the case of “consisting essentially of,” any additional compositions, materials, components, elements, features, integers, operations, and/or process steps that materially affect the basic and novel characteristics are excluded from such an embodiment, but any compositions, materials, components, elements, features, integers, operations, and/or process steps that do not materially affect the basic and novel characteristics can be included in the embodiment.

Any method steps, processes, and operations described herein are not to be construed as necessarily requiring their performance in the particular order discussed or illustrated, unless specifically identified as an order of performance. It is also to be understood that additional or alternative steps may be employed, unless otherwise indicated.

When a component, element, or layer is referred to as being “on,” “engaged to,” “connected to,” “attached to,” or “coupled to” another element or layer, it may be directly on, engaged, connected, attached or coupled to the other component, element, or layer, or intervening elements or layers may be present. In contrast, when an element is referred to as being “directly on,” “directly engaged to,” “directly connected to,” “directly attached to,” or “directly coupled to” another element or layer, there may be no intervening elements or layers present. Other words used to describe the relationship between elements should be interpreted in a like fashion (e.g., “between” versus “directly between,” “adjacent” versus “directly adjacent,” etc.). As used herein, the term “and/or” includes any and all combinations of one or more of the associated listed items.

Although the terms first, second, third, etc. may be used herein to describe various steps, elements, components, regions, layers and/or sections, these steps, elements, components, regions, layers and/or sections should not be limited by these terms, unless otherwise indicated. These terms may be only used to distinguish one step, element, component, region, layer or section from another step, element, component, region, layer or section. Terms such as “first,” “second,” and other numerical terms when used herein do not imply a sequence or order unless clearly indicated by the context. Thus, a first step, element, component, region, layer or section discussed below could be termed a second step, element, component, region, layer or section without departing from the teachings of the example embodiments.

Spatially or temporally relative terms, such as “before,” “after,” “inner,” “outer,” “beneath,” “below,” “lower,” “above,” “upper,” and the like, may be used herein for ease of description to describe one element or feature's relationship to another element(s) or feature(s) as illustrated in the figures. Spatially or temporally relative terms may be intended to encompass different orientations of the device or system in use or operation in addition to the orientation depicted in the figures. For example, if the device in the figures is turned over, elements described as “below” or “beneath” other elements or features would then be oriented “above” the other elements or features. Thus, the example term “below” can encompass both an orientation of above and below. The device may be otherwise oriented (rotated 90 degrees or at other orientations) and the spatially relative descriptors used herein interpreted accordingly.

It should be understood for any recitation of a method, composition, device, or system that “comprises” certain steps, ingredients, or features, that in certain alternative variations, it is also contemplated that such a method, composition, device, or system may also “consist essentially of” the enumerated steps, ingredients, or features, so that any other steps, ingredients, or features that would materially alter the basic and novel characteristics of the invention are excluded therefrom.

Throughout this disclosure, the numerical values represent approximate measures or limits to ranges to encompass minor deviations from the given values and embodiments having about the value mentioned as well as those having exactly the value mentioned. Other than in the working examples provided at the end of the detailed description, all numerical values of parameters (e.g., of quantities or conditions) in this specification, including the appended claims, are to be understood as being modified in all instances by the term “about” whether or not “about” actually appears before the numerical value. “About” indicates that the stated numerical value allows some slight imprecision (with some approach to exactness in the value; approximately or reasonably close to the value; nearly). If the imprecision provided by “about” is not otherwise understood in the art with this ordinary meaning, then “about” as used herein indicates at least variations that may arise from ordinary methods of measuring and using such parameters. For example, “about” may comprise a variation of less than or equal to 5%, optionally less than or equal to 4%, optionally less than or equal to 3%, optionally less than or equal to 2%, optionally less than or equal to 1%, optionally less than or equal to 0.5%, and in certain aspects, optionally less than or equal to 0.1%.

In addition, disclosure of ranges includes disclosure of all values and further divided ranges within the entire range, including endpoints and sub-ranges given for the ranges.

Example embodiments will now be described more fully with reference to the accompanying drawings.

### I. Electrochemical Cell

Lithium-containing electrochemical cells typically include a negative electrode, a positive electrode, an electrolyte for conducting lithium ions between the negative and positive electrodes, and a porous separator between the negative electrode and the positive electrode to physically separate and electrically insulate the electrodes from each other while permitting free ion flow. When assembled in an electrochemical cell, for example, in a lithium-ion battery, the porous separator is infiltrated with a liquid electrolyte. The present disclosure pertains to improved lithium-containing electrodes for lithium-containing electrochemical cells (e.g., lithium ion batteries). It has been discovered that inclusion of ceramic particles, as further described below, disposed on and/or within a lithium-containing electrode can improve the performance of the electrochemical cell. More specifically, the ceramic particles may improve various electro-mechanical properties (e.g., ion transport, stiffness) of the SEI layer and promote smooth deposition of to lithium thereby resulting in higher Coulombic efficiency, rate performance, and fast charge capability.

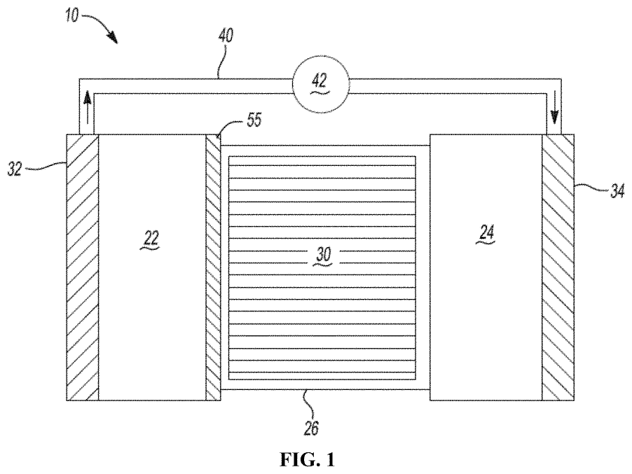

An electrochemical cell for use in batteries, for example, a lithium ion battery, or as capacitors is provided herein. For example, an exemplary and schematic illustration of an electrochemical cell (also referred to as the lithium ion battery or battery) 10 is shown in FIG. 1. Electrochemical cell 10 includes a negative electrode 22 (also referred to as a negative electrode layer 22), a positive electrode 24 (also referred to as a positive electrode layer 24), and a separator 26 (e.g., a microporous polymeric separator) disposed between the two electrodes 22, 24. The negative electrode 22 can also include ceramic particles 55, as further described below. The space between (e.g., the separator 26) the negative electrode 22 and positive electrode 24 can be filled with the electrolyte 30. If there are pores inside the negative electrode 22 and positive electrode 24, the pores may also be filled with the electrolyte 30. The electrolyte 30 can impregnate, infiltrate, or wet the surfaces of and fills the pores of each of the negative electrode 22, the positive electrode 24, and the porous separator 26. A negative electrode current collector 32 may be positioned at or near the negative electrode, 22 and a positive electrode current collector 34 may be positioned at or near the positive electrode 24. The negative electrode current collector 32 and positive electrode current collector 34 respectively collect and move free electrons to and from an external circuit 40. An interruptible external circuit 40 and load device 42 connects the negative electrode 22 (through its current collector 32) and the positive electrode 24 (through its current collector 34). Each of the negative electrode 22, the positive electrode 24, and the separator 26 may further comprise the electrolyte 30 capable of conducting lithium ions. The separator 26 operates as both an electrical insulator and a mechanical support, by being sandwiched between the negative electrode 22 and the positive electrode 24 to prevent physical contact and thus, the occurrence of a short circuit. The separator 26, in addition to providing a physical barrier between the two electrodes 22, 24, can provide a minimal resistance path for internal passage of lithium ions (and related anions) for facilitating functioning of the battery 10. The separator 26 also contains the electrolyte solution in a network of open pores during the cycling of lithium ions, to facilitate functioning of the battery 10.

The battery 10 can generate an electric current during discharge by way of reversible electrochemical reactions that occur when the external circuit 40 is closed (to connect the negative electrode 22 and the positive electrode 24) when the negative electrode 22 contains a relatively greater quantity of inserted lithium. The chemical potential difference between the positive electrode 24 and the negative electrode 22 drives electrons produced by the oxidation of inserted lithium at the negative electrode 22 through the external circuit 40 toward the positive electrode 24. Lithium ions, which are also produced at the negative electrode, are concurrently transferred through the electrolyte 30 and separator 26 towards the positive electrode 24. The electrons flow through the external circuit 40 and the lithium ions migrate across the separator 26 in the electrolyte 30 to form intercalated lithium at the positive electrode 24. The electric current passing through the external circuit 40 can be harnessed and directed through the load device 42 until the inserted lithium in the negative electrode 22 is depleted and the capacity of the lithium ion battery 10 is diminished.

The lithium ion battery 10 can be charged or re-powered/re-energized at any time by connecting an external power source to the lithium ion battery 10 to reverse the electrochemical reactions that occur during battery discharge. The connection of an external power source to the lithium ion battery 10 compels the otherwise non-spontaneous oxidation of intercalated lithium at the positive electrode 24 to produce electrons and lithium ions. The electrons, which flow back towards the negative electrode 22 through the external circuit 40, and the lithium ions, which are carried by the electrolyte 30 across the separator 26 back towards the negative electrode 22, reunite at the negative electrode 22 and replenish it with inserted lithium for consumption during the next battery discharge event. As such, a complete discharging event followed by a complete charging event is considered to be a cycle, where lithium ions are cycled between the positive electrode 24 and the negative electrode 22. The external power source that may be used to charge the lithium ion battery 10 may vary depending on the size, construction, and particular end-use of the lithium ion battery 10. Some notable and exemplary external power sources include, but are not limited to, an AC wall outlet and a motor vehicle alternator.

In many battery configurations, each of the negative current collector 32, negative electrode 22, the separator 26, positive electrode 24, and positive current collector 34 are prepared as relatively thin layers (for example, several microns or a millimeter or less in thickness) and assembled in layers connected in electrical parallel arrangement to provide a suitable energy package. The negative electrode current collector 32 and positive electrode current collector 34 respectively collect and move free electrons to and from an external circuit 40.

Furthermore, the battery 10 can include a variety of other components that while not depicted here are nonetheless known to those of skill in the art. For instance, the lithium ion battery 10 may include a casing, gaskets, terminal caps, tabs, battery terminals, and any other conventional components or materials that may be situated within the battery 120, including between or around the negative electrode 22, the positive electrode 24, and/or the separator 26, by way of non-limiting example. The battery 10 shown in FIG. 1 includes a liquid electrolyte 30 and shows representative concepts of battery operation.

As noted above, the size and shape of the lithium ion battery 10 may vary depending on the particular application for which it is designed. Battery-powered vehicles and hand-held consumer electronic devices, for example, are two examples where the battery 10 would most likely be designed to different size, capacity, and power-output specifications. The battery 10 may also be connected in series or parallel with other similar lithium ion cells or batteries to produce a greater voltage output and power density if it is required by the load device 42.

Accordingly, the battery 10 can generate electric current to a load device 42 that can be operatively connected to the external circuit 40. The load device 42 may be powered fully or partially by the electric current passing through the external circuit 40 when the lithium ion battery 10 is discharging. While the load device 42 may be any number of known electrically-powered devices, a few specific examples of power-consuming load devices include an electric motor for a hybrid vehicle or an all-electrical vehicle, a laptop computer, a tablet computer, a cellular phone, and cordless power tools or appliances, by way of non-limiting example. The load device 42 may also be a power-generating apparatus that charges the battery 10 for purposes of storing energy.

The present technology pertains to improved electrochemical cells, especially lithium-ion batteries. In various instances, such cells are used in vehicle or automotive transportation applications (e.g., motorcycles, boats, tractors, buses, motorcycles, mobile homes, campers, and tanks). However, the present technology may be employed in a wide variety of other industries and applications, including aerospace components, consumer goods, devices, buildings (e.g., houses, offices, sheds, and warehouses), office equipment and furniture, and industrial equipment machinery, agricultural or farm equipment, or heavy machinery, by way of non-limiting example.

### A. Negative Electrode with Ceramic Particles

In various aspects, a lithium metal electrode, such as negative electrode 22 (FIG. 1), including ceramic particles 55 (also referred to as ceramic powder) are provided herein. The negative electrode 22 includes an electroactive material (also referred to as a first electroactive material) as a lithium host material capable of functioning as a negative terminal of a lithium ion battery. The first electroactive material may be formed from or comprise metallic lithium. It is contemplated herein that the first electroactive material may be comprised of or consist of all metallic lithium (e.g., 100 wt % lithium based on total weight of the first electroactive material). Additionally or alternatively, the first electroactive material may comprise a lithium silicon alloy, a lithium aluminum alloy, a lithium indium alloy, a lithium tin alloy, or combinations thereof. The negative electrode 22 may optionally further include one or more of graphite, activated carbon, carbon black, hard carbon, soft carbon, graphene, silicon, tin oxide, aluminum, indium, zinc, germanium, silicon oxide, titanium oxide, lithium titanate, and combinations thereof, for example, silicon mixed with graphite. Non-limiting examples of silicon-containing electroactive materials include silicon (amorphous or crystalline), or silicon containing binary and ternary alloys, such as Si—Sn, SiSnFe, SiSnAl, SiFeCo, and the like. In other variations, the negative electrode 22 may be a metal film or foil, such as a lithium metal film or lithium-containing foil.

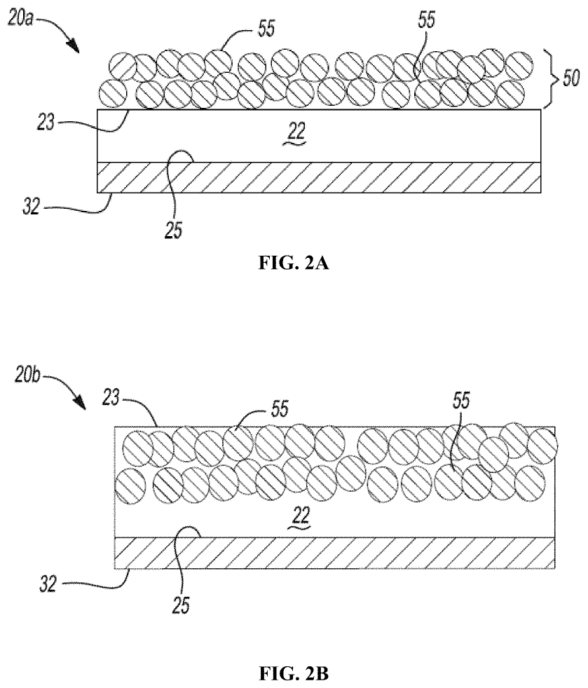

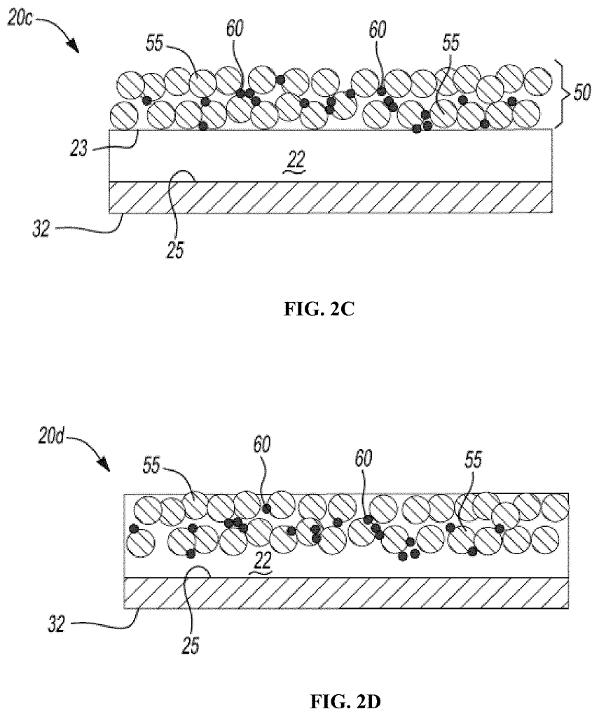

A magnified exemplary schematic of the negative electrode 22 including ceramic particles 55 is illustrated in FIG. 2A. In FIG. 2A, negative electrode configuration 20a includes a lithium-containing electrode, e.g., negative electrode 22, including a first surface 23, e.g., a first lithium-containing surface, and a second surface 25, e.g., a second lithium-containing surface, which is adjacent to or disposed on current collector 32.

In any embodiment, the ceramic particles 55 can include lithium lanthanum zirconium oxide (LLZO) particles, alumina (Al₂O₃ or aluminum oxide) particles, zirconia particles (ZrO₂ or zirconium dioxide) or a combination or mixture thereof. In some embodiments, only LLZO particles are present. In other embodiments, only alumina particles are present. In other embodiments, only alumina zirconia particles are present. In other embodiments, both LLZO particles and alumina particles are present, or both LLZO particles and zirconia particles are present, or both alumina particles and zirconia particles are present, or LLZO particles, alumina particles, and zirconia particles are present.

In any embodiment, the LLZO particles can be doped with any combination of suitable dopant, such as Al, Ca, Mg, Sr, Ba, Be, Ge, Ta, and/or Nb. For example, LLZO particles can be doped with Al or Ge on the Li site, Ca on the La site, Ta or Nb on the Zr site, in any combination that produces zero to one vacancies on the Li site per formula unit. LLZO can be doped to maintain cubic form, depending on the temperature. In any embodiment, the LLZO particles can correspond to the following one or more formulas: Li_{(7-3y)}Al_{y}La₃Zr₂O₁₂, where 0≤y≤⅔; Li_{7+x-3y-z}La₃₋ₓ(M)ₓ(N)_{y}Zr_{2-z}(Q)_{z}O₁₂, where M is Ca, Ba, Mg, or Sr; N is Al or (¾)Ge; Q is Ta or Nb; 0≤x≤1; 0≤y≤⅔; 0≤y≤⅔; 0≤z≤2; and 5≤(7+x−3y−z)≤7. Examples of compositions of LLZO particles include, but are not limited to, Li₇La₃Zr₂O₁₂, Li_{6.25}Al_{0.25}La₃Zr₂O₁₂, Li_{6.5}La₃Zr_{1.5}Ta_{0.5}O₁₂, or a combination thereof.

The alumina particles and zirconia particles may be present in any phase. For example, the zirconia particles may be present in monoclinic phase, tetragonal phase, cubic phase, or a combination thereof. In any embodiment, the alumina particles may comprise crystalline α-Al₂O₃ particles, β-Al₂O₃ particles, γ-Al₂O₃ particles, η-Al₂O₃ particles, θ-Al₂O₃ particles, κ-Al₂O₃ particles, ⋅-Al₂O₃ particles, σ-Al₂O₃ particles, or combinations thereof. In some embodiments, the alumina particles comprise α-Al₂O₃ particles.

In some embodiments, the ceramic particles may be pre-treated prior to application to the first surface 23 of the negative electrode 22 to improve lithium metal wettability. For example, the ceramic particles may be pre-treated with a coating, such as a Li₃PO₄ coating as described in U.S. patent application Ser. No. 16/791,158, the entirety of which is hereby incorporated by reference. Additionally or alternatively, the ceramic particles can be pre-treated via atomic layer deposition to apply an alumina or titania coating. Additionally or alternatively, the ceramic particles can be pre-treated via grinding or milling the ceramic particles, for example, in a ball mill, to reduce the size of the ceramic particles

In any embodiment, as illustrated in FIG. 2A, ceramic particles 55 may be present as a ceramic layer 50 adjacent to or disposed on at least a portion of the first surface 23 of the negative electrode 22. In such embodiments, when present in cell 10, the ceramic layer 50 may be disposed between the negative electrode 22 and the separator 26. In various aspects, the ceramic layer 50 may be substantially continuous or may be substantially discontinuous. The ceramic coating 50 may have thickness of greater than or equal to about 100 nm, greater than or equal to about 500 nm, greater than or equal to about 1 μm, greater than or equal to about 10 μm, greater than or equal to about 25 μm, greater than or equal to about 50 μm, greater than or equal to about 75 μm, greater than or equal to about 100 μm, greater than or equal to about 200 μm, or about 400 μm; or from about 100 nm to about 400 μm, about 500 nm to about 200 μm, about 1 um to about 100 μm, or about 10 μm to about 75 μm. In any embodiment, the ceramic layer 50 may be bonded to the first surface 23 via electrostatic interactions. Additionally or alternatively, when LLZO particles are exposed to air, Li₂CO₃ and LiOH can form and promote adhesion of the ceramic particles 55 to the first surface 23.

Additionally or alternatively, as illustrated in FIG. 2B in negative electrode configuration 20b, ceramic particles 55 may be embedded within, onto, and/or into the first surface 23 of the negative electrode 22. In such an embodiment, a portion of ceramic particles 55 may be exposed at the first surface 23 of the negative electrode 22. Although not show, it is also contemplated herein that the ceramic particles 55 can be present both as ceramic layer 50 and embedded within the first surface 23 of the negative electrode 22. When present, the LLZO particles may be present on the negative electrode 22 (e.g., in ceramic layer 50 or embed within first surface 23) in an amount of greater than or equal to about 0.5 g/cm², greater than or equal to about 1 g/cm², greater than or equal to about 5 g/cm², greater than or equal to about 10 g/cm², greater than or equal to about 20 g/cm², greater than or equal to about 30 g/cm², greater than or equal to about 40 g/cm², or about 50 g/cm², or from about 0.5 g/cm² to about 50 g/cm², about 0.5 g/cm² to about 40 g/cm², about 0.5 g/cm² to about 30 g/cm², about 1 g/cm² to about 20 g/cm², about 1 g/cm² to about 10 g/cm², or about 3 g/cm² to about 9 g/cm². Additionally, when present, the alumina particle may be present on the negative electrode 22 (e.g., in ceramic layer 50 or embed within first surface 23) in an amount of greater than or equal to about 0.4 g/cm², greater than or equal to about 1 g/cm², greater than or equal to about 5 g/cm², greater than or equal to about 10 g/cm², greater than or equal to about 20 g/cm², greater than or equal to about 30 g/cm², or about 40 g/cm², or from about 0.4 g/cm² to about 40 g/cm², about 0.4 g/cm² to about 30 g/cm², about 1 g/cm² to about 20 g/cm², about 1 g/cm² to about 10 g/cm², or about 2 g/cm² to about 8 g/cm². Additionally, when present, the zirconia particles may be present on the negative electrode 22 (e.g., in ceramic layer 50 or embed within first surface 23) in an amount of greater than or equal to about 0.5 g/cm², greater than or equal to about 1 g/cm², greater than or equal to about 5 g/cm², greater than or equal to about 10 g/cm², greater than or equal to about 20 g/cm², greater than or equal to about 30 g/cm², greater than or equal to about 40 g/cm², or about 50 g/cm², or from about 0.5 g/cm² to about 50 g/cm², about 0.5 g/cm² to about 40 g/cm², about 0.5 g/cm² to about 30 g/cm², about 1 g/cm² to about 20 g/cm², about 1 g/cm² to about 10 g/cm², or about 3 g/cm² to about 9 g/cm².

The LLZO particles, the alumina particles, and the zirconia particles each may have any average particle diameter of greater than or equal to about 50 nm, greater than or equal to about 100 nm, greater than or equal to about 500 nm, greater than or equal to about 750 nm, greater than or equal to about 1 μm, greater than or equal to about 5μm, greater than or equal to about 10 μm, greater than or equal to about 15 μm, greater than or equal to about 20 μm, greater than or equal to about 30 μm, or about 50 μm; or from about 50 nm to about 50 μm, about 100 nm to about 20 μm, about 500 nm to about 15 μm, or about 1 μm to about 10 μm.

As stated above, an SEI layer can form on the negative electrode during cycling of the electrochemical cell. Without being bound by theory, it is believed that the ceramic particles (e.g., LLZO particles and/or alumina particles) embedded may improve the ionic transport of lithium ions through the SEI layer as well as the mechanical robustness of the SEI layer, which may result in smoother lithium metal stripping and plating thereby increasing Coulombic efficiency. Additionally, without being bound by theory, it is believed that the ceramic particles (e.g., LLZO particles and/or alumina particles) embedded within or onto the first surface of the negative electrode may increase the surface area of the lithium-containing negative electrode available for stripping and plating without additional exposure to the electrolyte thereby resulting in improved rate performance and fast charge capability. Furthermore, as the electrochemical cell operates and an SEI layer forms on the surface (e.g., first surface 23) of the negative electrode (e.g., negative electrode 22), the ceramic particles can become embedded within the SEI layer. Without being bound by theory, it is believed that the ceramic particles embedded within the SEI layer can advantageously promote even lithium ion current distribution, reduce SEI resistance, increase SEI stiffness, and scavenge hydrofluoric acid (HF). Hydrofluoric acid is highly corrosive and may be generated in the electrochemical cell 10 during decomposition of the electrolyte. The as-produced HF may increase the acidity of the liquid electrolyte 30, which may lead to corrosion of the positive electrode and/or the current collectors 32, 34. HF can also decompose an existing SEI layer leading to more electrolyte consumption. Therefore, by functioning as an HF scavenger, ceramic particles may help reduce corrosion and degradation of the various components of the cell 10.

Additionally or alternatively, the ceramic particles 55 may also include a binder 60. As illustrated in FIGS. 2C and 2D, binder 60 may be present as discrete particles or fragments in negative electrode configurations 20c, 20d. Additionally or alternatively binder 60 may be present as a more continuous phase in which the ceramic particles 55 are dispersed. Examples of a suitable binder 60, include but are not limited to, polyacrylonitrile (PAN), polyimide, polyvinylpyrrolidone (PVP), polyvinyl butyral, polyvinyl acetate, methyl cellulose, ethyl cellulose, polyacrylate esters, polyurethane, polyethylene glycol, acrylic compounds, polystyrene, polyvinyl alcohol, polymethylmethacrylate, polybutylmethacrylate, and combinations thereof. In any embodiment, binder 60 can coat at least a portion of the surface ceramic particles 55 or binder 60 can coat substantially the entire surface of ceramic particles 55. In some embodiments, binder 60 should only partially coat the surface of the ceramic particles 55, or dissolve in situ (e.g., when contacted with the electrolyte), and not coat the entire surface of the ceramic particles 55, so as not to render the ceramic particles 55 insulated and inert.

If present, the binder 60 may be present in amount, based on total weight of the ceramic particles and binder (e.g., total weight of the ceramic coating 50), of less than or equal to about 40 wt %, less than or equal to about 30 wt %, less than or equal to about 20 wt %, less than or equal to about 10 wt %, or less than or equal to about 5 wt % or about 1 wt %; or from about 1 wt % to about 40 wt %, about 1 wt % to about 30 wt %, about 5 wt % to about 30 wt %, or about 1 wt % to about 10 wt %. In alternative embodiments, no binder is present with the ceramic particles 55.

In some embodiments, the negative electrode 22 may have a small amount of a passivation layer (less than 20%, less than 10%, less than 5% of the original passivation layer) or does not have substantially any (less than 1%) passivation layer present on the first surface 23, for example, between the first surface 23 and the ceramic layer 50.

Additionally, the negative electrode 22 can optionally include an electrically conductive material and/or a polymeric binder, for example, in embodiments where the negative electrode 22 is not 100% lithium metal. Examples of electrically conductive material include, but are not limited to, carbon black, graphite, acetylene black (such as KETCHEN™ black or DENKA™ black), carbon nanotubes, carbon fibers, carbon nanofibers, graphene, graphene nanoplatelets, graphene oxide, nitrogen-doped carbon, metallic powder (e.g., copper, nickel, steel), liquid metals (e.g., Ga, GaInSn), a conductive polymer (e.g., include polyaniline, polythiophene, polyacetylene, polypyrrole, and the like) and combinations thereof. Such electrically conductive material in particle form may have a round geometry or an axial geometry as described above. As used herein, the term “graphene nanoplatelet” refers to a nanoplate or stack of graphene layers.

As used herein, the term “polymeric binder” includes polymer precursors used to form the polymeric binder, for example, monomers or monomer systems that can form any one of the polymeric binders disclosed above. Examples of suitable polymeric binders, include but are not limited to, polyvinylidene difluoride (PVdF), polytetrafluoroethylene (PTFE), ethylene propylene diene monomer (EPDM) rubber, or carboxymethyl cellulose (CMC), a nitrile butadiene rubber (NBR), styrene-butadiene rubber (SBR), lithium polyacrylate (LiPAA), sodium polyacrylate (NaPAA), poly(acrylic acid) PAA, polyimide, polyamide, sodium alginate, lithium alginate, and combinations thereof. In some embodiments, the polymeric binder may be a non-aqueous solvent-based polymer or an aqueous-based polymer. In particular, the polymeric binder may be a non-aqueous solvent-based polymer that can demonstrate less capacity fade, provide a more robust mechanical network and improved mechanical properties to handle silicon particle expansion more effectively, and possess good chemical and thermal resistance. For example, the polymeric binder may include polyimide, polyamide, polyacrylonitrile, polyacrylic acid, a salt (e.g., potassium, sodium, lithium) of polyacrylic acid, polyacrylamide, polyvinyl alcohol, carboxymethyl cellulose, or a combination thereof. The first electroactive material may be intermingled with the electrically conductive material and at least one polymeric binder. For example, the first electroactive materials and optional electrically conducting materials may be slurry cast with such binders and applied to a current collector. Polymeric binder can fulfill multiple roles in an electrode, including: (i) enabling the electronic and ionic conductivities of the composite electrode, (ii) providing the electrode integrity, e.g., the integrity of the electrode and its components, as well as its adhesion with the current collector, and (iii) participating in the formation of solid electrolyte interphase (SEI), which plays an important role as the kinetics of lithium intercalation is predominantly determined by the SEI.

In various aspects, the first electroactive material may be present in the negative electrode in an amount, based on total weight of the negative electrode from about 50 wt % to about 100 wt %, about 50 wt % to about 98 wt %, about 60 wt % to about 95 wt %, about 60 wt % to about 95 wt %, or about 60 wt % to about 80 wt %. Additionally or alternatively, the electrically conductive material may be present in the negative electrode in an amount, based on total weight of the negative electrode, from about 0.2 wt % to about 25 wt %, about 1 wt % to about 25 wt %, about 2 wt % to about 20 wt %, about 5 wt % to about 15 wt %, or about 2 wt % to about 10 wt %. Additionally or alternatively, the polymeric binder may be present in the negative electrode in an amount, based on total weight of the negative electrode from about 0.5 wt % to about 30 wt %, about 1 wt % to about 25 wt %, about 3 wt % to about 20 wt %, or about 5 wt % to about 15 wt %.

### B. Positive Electrode

The positive electrode 24 may be formed from a second electroactive material that can sufficiently undergo lithium intercalation and deintercalation while functioning as the positive terminal of the lithium ion battery 10. The positive electrode 24 may also include a polymeric binder material to structurally fortify the lithium-based active material and an electrically conductive material. One exemplary common class of known materials that can be used to form the positive electrode 24 is layered lithium transitional metal oxides. For example, in certain embodiments, the positive electrode 24 may comprise Li₍₁₊ₓ₎Mn₂O₄, where 0.1≤x≤1; LiMn₍₂₋ₓ₎NiₓO₄, where 0≤x≤0.5; LiCoO₂; Li(NiₓMn_{y}Co_{z})O₂, where 0≤x≤1, 0≤y≤1, 0≤z≤1, and x+y+z=1; LiNi_{(1-x-y)}CoₓM_{y}O₂, where 0≤x≤0.2, y≤0.2, and M is Al, Mg, or Ti; LiFePO₄, LiMn₂₋ₓFexPO₄, where 0≤x≤0.3; LiNiCoAlO₂; LiMPO₄, where M is at least one of Fe, Ni, Co, and Mn; Li(NiₓMn_{y}Co_{z}Alₚ)O₂, where 0≤x≤1, 0≤y≤1, 0≤z≤1, 0≤P≤1, x+y+z+p=1 (NCMA); LiNiMnCoO₂; Li₂FeₓM₁₋ₓPO₄, where M is Mn and/or Ni, 0≤x≤1; LiMn₂O₄; LiFeSiO₄; LiNi_{0.6}Mn_{0.2}Co_{0.2}O₂ (NMC622), LiMnO₂ (LMO), activated carbon, sulfur (e.g., greater than 60 wt % based on total weight of the positive electrode), or combinations thereof.

In certain variations, the second electroactive materials may be intermingled with an electronically conductive material as described herein that provides an electron conduction path and/or at least one polymeric binder material as described herein that improves the structural integrity of the electrode. For example, the second electroactive materials and electronically or electrically conducting materials may be slurry cast with such binders, like polyvinylidene difluoride (PVdF), polytetrafluoroethylene (PTFE), ethylene propylene diene monomer (EPDM) rubber, or carboxymethyl cellulose (CMC), a nitrile butadiene rubber (NBR), styrene-butadiene rubber (SBR), lithium polyacrylate (LiPAA), sodium polyacrylate (NaPAA), poly(acrylic acid) PAA, polyimide, polyamide, sodium alginate, or lithium alginate, and applied to a current collector.

### C. Current Collectors

The positive electrode current collector 34 may be formed from aluminum (Al) or any other appropriate electrically conductive material known to those of skill in the art. The negative electrode current collector 32 may comprise a metal comprising copper, nickel, or alloys thereof, stainless steel, or other appropriate electrically conductive materials known to those of skill in the art. In certain aspects, the positive electrode current collector 34 and/or negative electrode current collector 32 may be in the form of a foil, slit mesh, and/or woven mesh.

### D. Electrolyte

The positive electrode 24, the negative electrode 22, and the separator 26 may each include an electrolyte solution or system 30 inside their pores, capable of conducting lithium ions between the negative electrode 22 and the positive electrode 24. Any appropriate electrolyte 30, whether in solid, liquid, or gel form, capable of conducting lithium ions between the negative electrode 22 and the positive electrode 24 may be used in the lithium-ion battery 10. In certain aspects, the electrolyte 30 may be a non-aqueous liquid electrolyte solution that includes a lithium salt dissolved in an organic solvent or a mixture of organic solvents. Numerous conventional non-aqueous liquid electrolyte 30 solutions may be employed in the lithium-ion battery 10.

In certain aspects, the electrolyte 30 may be a non-aqueous liquid electrolyte solution that includes one or more lithium salts dissolved in an organic solvent or a mixture of organic solvents. For example, a non-limiting list of lithium salts that may be dissolved in an organic solvent to form the non-aqueous liquid electrolyte solution include lithium hexafluorophosphate (LiPF₆), lithium perchlorate (LiClO₄), lithium tetrachloroaluminate (LiAlCl₄), lithium iodide (LiI), lithium bromide (LiBr), lithium thiocyanate (LiSCN), lithium tetrafluorob orate (LiBF₄), lithium tetraphenylborate (LiB(C₆H₅)₄), lithium bis(oxalato)borate (LiB(C₂O₄)₂) (LiBOB), lithium difluorooxalatoborate (LiBF₂(C₂O₄)), lithium hexafluoroarsenate (LiAsF₆), lithium trifluoromethanesulfonate (LiCF₃SO₃), lithium bis(trifluoromethane)sulfonylimide (LiN(CF₃SO₂)₂), lithium bis(fluorosulfonyl)imide (LiN(FSO₂)₂) (LiSFI), lithium (triethylene glycol dimethyl ether)bis(trifluoromethanesulfonyl)imide (Li(G3)(TFSI), lithium bis(trifluoromethanesulfonyl)azanide (LiTFSA), and combinations thereof.

These and other similar lithium salts may be dissolved in a variety of non-aqueous aprotic organic solvents, including but not limited to, various alkyl carbonates, such as cyclic carbonates (e.g., ethylene carbonate (EC), propylene carbonate (PC), butylene carbonate (BC), fluoroethylene carbonate (FEC)), linear carbonates (e.g., dimethyl carbonate (DMC), diethyl carbonate (DEC), ethylmethylcarbonate (EMC)), aliphatic carboxylic esters (e.g., methyl formate, methyl acetate, methyl propionate), γ-lactones (e.g., γ-butyrolactone, γ-valerolactone), chain structure ethers (e.g., 1,2-dimethoxyethane, 1-2-diethoxyethane, ethoxymethoxyethane), cyclic ethers (e.g., tetrahydrofuran, 2-methyltetrahydrofuran), 1,3-dioxolane). One or more salts can be present in the electrolyte in a concentration ranging from about 1 M to about 4 M, for example, about 1 M, about 1 M to 2 M, or about 3 M to about 4 M. sulfur compounds (e.g., sulfolane), acetonitrile, and combinations thereof.

Additionally or alternatively, the electrolyte may include additives, which can, for example, increase temperature and voltage stability of the electrochemical cell materials (e.g., electrolyte 30, negative electrode 22, and positive electrode 24). Examples of suitable additives include, but are not limited to, vinyl carbonate, vinyl-ethylene carbonate, propane sulfonate, and combinations therefore. Other additives can include diluents which do not coordinate with lithium ions but can reduce viscosity, such as bis(2,2,2-trifluoroethyl) ether (BTFE), and flame retardants, such as triethyl phosphate.

### E. Separator

The separator 26 may comprise, for example, a microporous polymeric separator comprising a polyolefin or PTFE. The polyolefin may be a homopolymer (derived from a single monomer constituent) or a heteropolymer (derived from more than one monomer constituent), which may be either linear or branched. If a heteropolymer is derived from two monomer constituents, the polyolefin may assume any copolymer chain arrangement, including those of a block copolymer or a random copolymer. Similarly, if the polyolefin is a heteropolymer derived from more than two monomer constituents, it may likewise be a block copolymer or a random copolymer. In certain aspects, the polyolefin may be polyethylene (PE), polypropylene (PP), or a blend of PE and PP, or multi-layered structured porous films of PE and/or PP. Commercially available polyolefin porous separator membranes include CELGARD® 2500 (a monolayer polypropylene separator) and CELGARD® 2325 (a trilayer polypropylene/polyethylene/polypropylene separator) available from Celgard LLC.

In certain aspects, the separator 26 may further include one or more of a ceramic coating layer and a heat-resistant material coating. The ceramic coating layer and/or the heat-resistant material coating may be disposed on one or more sides of the separator 26. The material forming the ceramic layer may be selected from the group consisting of: alumina (Al₂O₃), silica (SiO₂), and combinations thereof. The heat-resistant material may be selected from the group consisting of: Nomex, Aramid, and combinations thereof.

When the separator 26 is a microporous polymeric separator, it may be a single layer or a multi-layer laminate, which may be fabricated from either a dry or a wet process. For example, in certain instances, a single layer of the polyolefin may form the entire separator 26. In other aspects, the separator 26 may be a fibrous membrane having an abundance of pores extending between the opposing surfaces and may have an average thickness of less than a millimeter, for example. As another example, however, multiple discrete layers of similar or dissimilar polyolefins may be assembled to form the microporous polymer separator 26. The separator 26 may also comprise other polymers in addition to the polyolefin such as, but not limited to, polyethylene terephthalate (PET), polyvinylidene fluoride (PVdF), a polyamide, polyimide, poly(amide-imide) copolymer, polyetherimide, and/or cellulose, or any other material suitable for creating the required porous structure. The polyolefin layer, and any other optional polymer layers, may further be included in the separator 26 as a fibrous layer to help provide the separator 26 with appropriate structural and porosity characteristics. In certain aspects, the separator 26 may also be mixed with a ceramic material or its surface may be coated in a ceramic material. For example, a ceramic coating may include alumina (Al₂O₃), silicon dioxide (SiO₂), titania (TiO₂) or combinations thereof. Various conventionally available polymers and commercial products for forming the separator 26 are contemplated, as well as the many manufacturing methods that may be employed to produce such a microporous polymer separator 26.

In various aspects, the porous separator 26 and the electrolyte 30 in FIG. 1 may be replaced with a solid-state electrolyte (SSE) (not shown) that functions as both an electrolyte and a separator. The SSE may be disposed between the positive electrode 24 and negative electrode 22. The SSE facilitates transfer of lithium ions, while mechanically separating and providing electrical insulation between the negative and positive electrodes 22, 24. By way of non-limiting example, SSEs may include LiTi₂(PO₄)₃, LiGe₂(PO₄)₃, Li₇La₃Zr₂O₁₂, Li₃xLa_{2/3}-xTiO₃, Li₃PO₄, Li₃N, Li₄GeS₄, Li₁₀GeP₂S₁₂, Li₂S-P₂S₅, Li₆PS₅Cl, Li₆PS₅Br, Li₆PS₅I, Li₃OCl, Li_{2.99}Ba_{0.005}ClO, or combinations thereof.

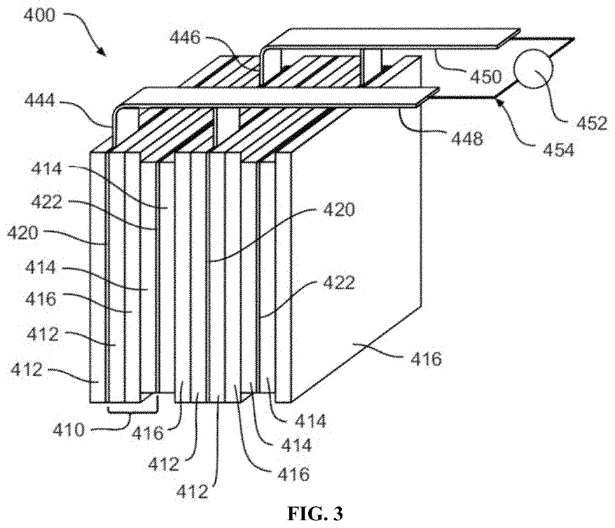

Referring now to FIG. 3, the electrochemical cell 10 (as shown in FIG. 1) may be combined with one or more other electrochemical cells to produce a lithium ion battery 400. The lithium ion battery 400 illustrated in FIG. 3 includes multiple rectangular-shaped electrochemical cells 410. Anywhere from 5 to 150 electrochemical cells 410 may be stacked side-by-side in a modular configuration and connected in series or parallel to form a lithium ion battery 400, for example, for use in a vehicle powertrain. The lithium ion battery 400 can be further connected serially or in parallel to other similarly constructed lithium ion batteries to form a lithium ion battery pack that exhibits the voltage and current capacity demanded for a particular application, e.g., for a vehicle. It should be understood the lithium ion battery 400 shown in FIG. 3 is only a schematic illustration, and is not intended to inform the relative sizes of the components of any of the electrochemical cells 410 or to limit the wide variety of structural configurations a lithium ion battery 400 may assume. Various structural modifications to the lithium ion battery 400 shown in FIG. 3 are possible despite what is explicitly illustrated.

Each electrochemical cell 410 includes a negative electrode 412, a positive electrode 414, and a separator 416 situated between the two electrodes 412, 414. One or more of the negative electrode 412 can include the ceramic particles 55 (not shown) as described herein. Each of the negative electrode 412, the positive electrode 414, and the separator 416 is impregnated, infiltrated, or wetted with a liquid electrolyte (e.g., electrolyte 30) capable of transporting lithium ions. A negative electrode current collector 420 that includes a negative polarity tab 444 is located between the negative electrodes 412 of adjacent electrochemical cells 410. Likewise, a positive electrode current collector 422 that includes a positive polarity tab 446 is located between neighboring positive electrodes 424. The negative polarity tab 444 is electrically coupled to a negative terminal 448 and the positive polarity tab 446 is electrically coupled to a positive terminal 450. An applied compressive force usually presses the current collectors 420, 422, against the electrodes 412, 414 and the electrodes 412, 414 against the separator 416 to achieve intimate interfacial contact between the several contacting components of each electrochemical cell 410.

The battery 400 may include more than two pairs of positive and negative electrodes 412, 414. In one form, the battery 400 may include 15-60 pairs of positive and negative electrodes 412, 414. In addition, although the battery 400 depicted in FIG. 3 is made up of a plurality of discrete electrodes 412, 414 and separators 416, other arrangements are certainly possible. For example, instead of discrete separators 416, the positive and negative electrodes 412, 414 may be separated from one another by winding or interweaving a single continuous separator sheet between the positive and negative electrodes 412, 414. In another example, the battery 400 may include continuous and sequentially stacked positive electrode, separator, and negative electrode sheets folded or rolled together to form a “jelly roll.”

The negative and positive terminals 448, 450 of the lithium ion battery 400 are connected to an electrical device 452 as part of an interruptible circuit 454 established between the negative electrodes 412 and the positive electrodes 414 of the many electrochemical cells 410. The electrical device 452 may comprise an electrical load or power-generating device. An electrical load is a power-consuming device that is powered fully or partially by the lithium ion battery 400. Conversely, a power-generating device is one that charges or re-powers the lithium ion battery 400 through an applied external voltage. The electrical load and the power-generating device can be the same device in some instances. For example, the electrical device 452 may be an electric motor for a hybrid electric vehicle or an extended range electric vehicle that is designed to draw an electric current from the lithium ion battery 400 during acceleration and provide a regenerative electric current to the lithium ion battery 400 during deceleration. The electrical load and the power-generating device can also be different devices. For example, the electrical load may be an electric motor for a hybrid electric vehicle or an extended range electric vehicle and the power-generating device may be an AC wall outlet, an internal combustion engine, and/or a vehicle alternator.

The lithium ion battery 400 can provide a useful electrical current to the electrical device 452 by way of the reversible electrochemical reactions that occur in the electrochemical cells 410 when the interruptible circuit 454 is closed to connect the negative terminal 448 and the positive terminal 450 at a time when the negative electrodes 412 contain a sufficient quantity of intercalated lithium (i.e., during discharge). When the negative electrodes 412 are depleted of intercalated lithium and the capacity of the electrochemical cells 410 is spent. The lithium ion battery 400 can be charged or re-powered by applying an external voltage originating from the electrical device 452 to the electrochemical cells 410 to reverse the electrochemical reactions that occurred during discharge.

Although not depicted in the drawings, the lithium ion battery 400 may include a wide range of other components. For example, the lithium ion battery 400 may include a casing, gaskets, terminal caps, and any other desirable components or materials that may be situated between or around the electrochemical cells 410 for performance related or other practical purposes. For example, the lithium ion battery 400 may be enclosed within a case (not shown). The case may comprise a metal, such as aluminum or steel, or the case may comprise a film pouch material with multiple layers of lamination. It is contemplated herein that the electrochemical cell 10, 400 that is formed may be a pouch cell, coin cell, or another full electrochemical cell having a cylindrical format or wounded prismatic format

### II. Method of Preparing a Lithium-Containing Electrode with Ceramic Particles

Methods of preparing a lithium-containing electrode, for example, negative electrode 22, are also provided herein. The method includes applying ceramic particles (e.g., ceramic particles 55) to a surface (e.g., first surface 23) of a negative electrode (e.g., negative electrode 22). Application of the ceramic particles can include any suitable dry casting/coating or slurry casting/coating methods. Such methods include, but are not limited to, spray coating, knife-over-edge coating, slot die coating, direct gravure coating, and micro-gravure coating, for example, as described in J. Park et al., Int'l J. of Precision Eng. And Manf., 17, 4 (2016), pp. 1-14. Other application methods include bar coating, drop casting, spin coating, doctor blading, and dip coating. As described above, the ceramics particles or powder may be pre-treated before being applied to the negative electrode; thus, the methods provided herein may include one or more of the pre-treatment steps described above.

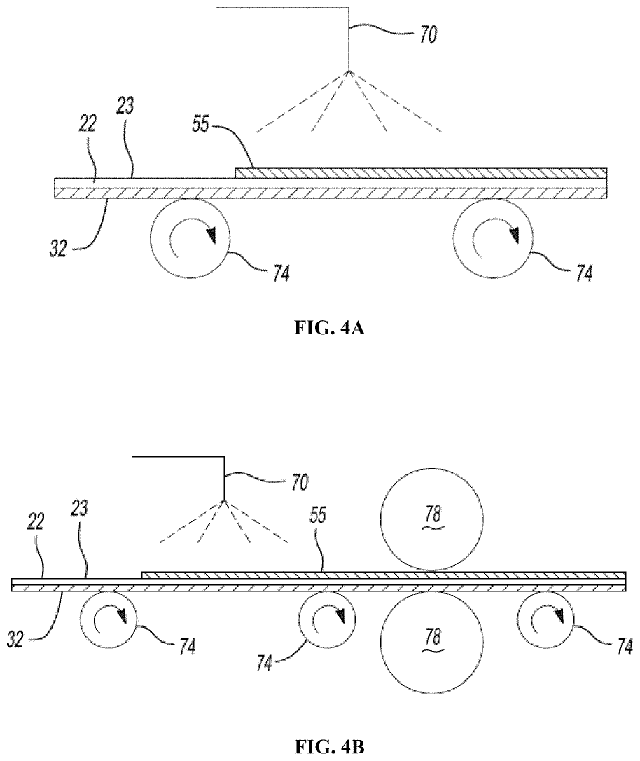

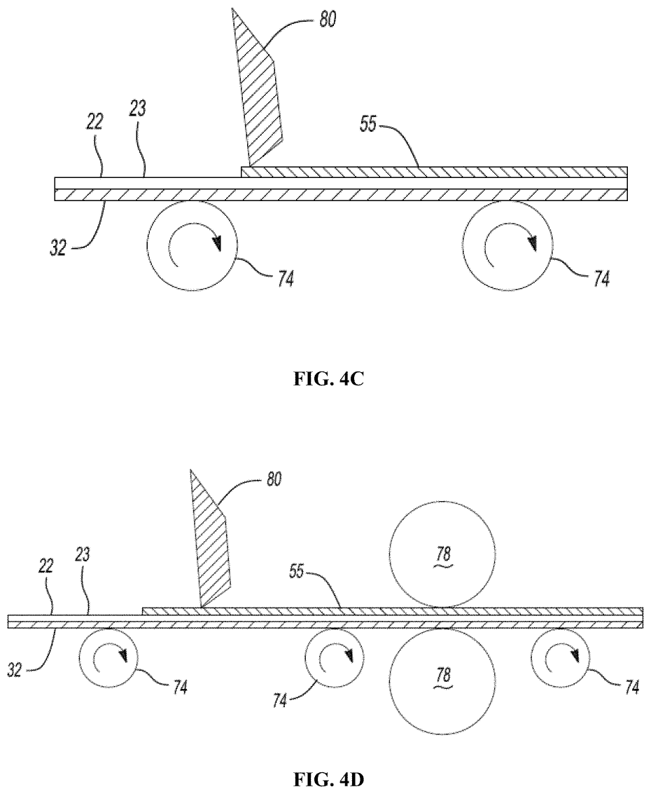

An example of dry casting is illustrated in FIG. 4A. In FIG. 4A, as negative electrode 22, which is disposed on a current collector 32, is conveyed via rollers 74, ceramic particles 55 may be sprayed onto first surface 23 of the negative electrode 22 via a spraying device 70 and form ceramic layer 50. Examples of suitable spraying device 70 includes, but are not limited to, a tribo spray gun, corona spray gun, or electrostatic spray gun. It is contemplated herein that the ceramic powder may be present in suspension and sprayed on the first surface 23 via spraying device 70. In any embodiment, the spray device 70 can impart a charge (e.g., positive charge) to the ceramic particles 55 to improve adhesion to the negative electrode 22. Binder 60 may be optionally sprayed along with the ceramic particles 55 via the spraying device 70.

An example of slurry casting is illustrated in FIG. 4C. For slurry casting, the ceramic particles 55 and optional binder 60 may be admixed with a solvent to form a slurry. Non-limiting examples of suitable solvents include xylene, hexane, methyl ethyl ketone, acetone, toluene, dimethylformamide, aromatic hydrocarbons, n-methyl-2-pyrrolidone (NMP), and combinations thereof. In FIG. 4C, as negative electrode 22, which is disposed on a current collector 32, is conveyed via rollers 74, the slurry containing the ceramic particles 55 and optional binder 60 may be applied onto first surface 23 of the negative electrode 22 via a slurry application device 80. Examples of a slurry application device 80 include, but are not limited to, a knife, a slot die, direct gravure coating, or micro-gravure coating. Following application of the slurry onto the negative electrode 22, the method may further include a drying or volatilization step to remove the solvent present in the applied slurry to form the ceramic layer 50. Drying can be performed at a temperature suitable to volatilize the solvent, for example, about 45° C. to 150° C.

The ceramic particles 55 may be applied, e.g., dry cast or slurry cast, under inert and/or dry room conditions. For example, the methods may be performed at low humidity conditions, e.g., at 10% relative humidity (RH) or lower, e.g., 5% RH, 1% RH (−35° C. or lower dew point). The methods may be performed a temperature of 5° C. to 150° C.

Optionally, as illustrated in FIGS. 4B and 4D, after the ceramic particles 55 are applied to the first surface 23 of negative electrode 22, the negative electrode 22 with ceramic particles 55 present thereon in ceramic layer 50 may be conveyed through rollers 78 of a roll press in order to embed at least a portion of the ceramic particles 55 within or onto the first surface 23 of the negative electrode 22. Pressure may be applied to the ceramic particles 55 via rollers 78 in a range of about 0.1 MPa to about 100 MPa. When the ceramic particles 55 are applied via slurry casting, the drying or volatilization step may occur prior to rolling of the negative electrode 22 with the ceramic particles 55 disposed thereon through the roll press.

### EXAMPLES

### General Information

Unless otherwise indicated below ceramic particles used were either Li₇La₃Zr₂O₁₂ powder (obtained from NEI Corporation) (LLZO particles) or α-Al₂O₃ powder (obtained from Alfa Aesar) (alumina particles). The alumina particles where prepared by grinding with an agate mortar and pestle and 200 mesh sieve. The LLZO particles and alumina particles had an average particle diameter less than 75 μm, e.g., 2 μm to 5 μm range.

Unless otherwise indicated below, to form the negative electrode with ceramic particles, the LLZO particles or the alumina particles were applied via spray casting onto a lithium metal foil (90 μm thick on stainless steel alloy SUS 10 μm thick) utilizing a bulb syringe attached to PTFE tubing to deliver the ceramic particles. The electronegative PTFE tubing imparted a positive charge to the ceramic particles to improve adhesion to the lithium metal foil. Loading of the ceramic particles onto the lithium metal foil was varied by changing the number of coating passes. After application of the ceramic particles, a borosilicate glass vial was rolled over the lithium metal foil to embed the ceramic particles into the lithium metal surface.

Unless otherwise indicated below, each of the cells prepared in the Examples below were composed of a cathode (LiNi_{0.6}Mn_{0.2}Co_{0.2}O₂) (NMC622), an anode prepared as described above, and 30 μl 1 M LiPF₆ in ethyl methyl carbonate and fluoroethylene carbonate as the electrolyte with a polyolefin separator (Celgard® C210).

Unless otherwise indicated below, each of the cells prepared in the Examples below were tested as follows: Basic cycling protocol: voltage range=3.0-4.3 V; First 3 cycles at a C/10 charge and discharge rate (0.6 mA); every cycle thereafter at a C/3 charge and discharge rate (2 mA). Fast charge cycling protocol: same as basic cycling protocol except every 5^{th} cycle starting after the 3 first formation cycles occurs at a ⅔C rate (4 mA).

### Example 1

The following anodes were prepared as described above with varying LLZO particle loadings as shown below in Table 1.

TABLE 1

| Anode | LLZO Loading |
|---|---|
| 1 | 4.5 mg/cm² |
| 2 | 4.6 mg/cm² |
| 3 | 5.7 mg/cm² |
| 4 | 6.1 mg/cm² |
| 5 | 6.3 mg/cm² |
| 6 | 8.8 mg/cm² |

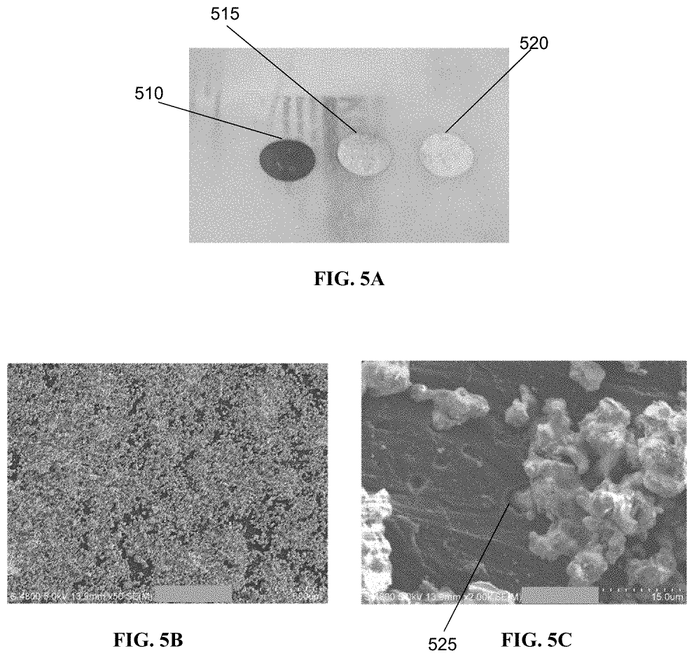

FIG. 5A is a photographic image of a control anode (lithium metal foil 90 μm thick on SUS 10 μm thick) without ceramic particles (510), Anode 2 (515), and Anode 6 (520). FIGS. 5B and 5C are scanning electron microscopy (SEM) images of Anode 2 (515). FIG. 5C, a magnification of FIG. 5B, shows the embedded LLZO particles (525) on the surface of the lithium metal anode.

### Example 2

Cells 1-6 were each prepared with respective Anodes 1-6 and a cathode, a separator, and an electrolyte as described above. Control Cell A was prepared with the control anode in Example 1 and a cathode, a separator, and an electrolyte as described above.

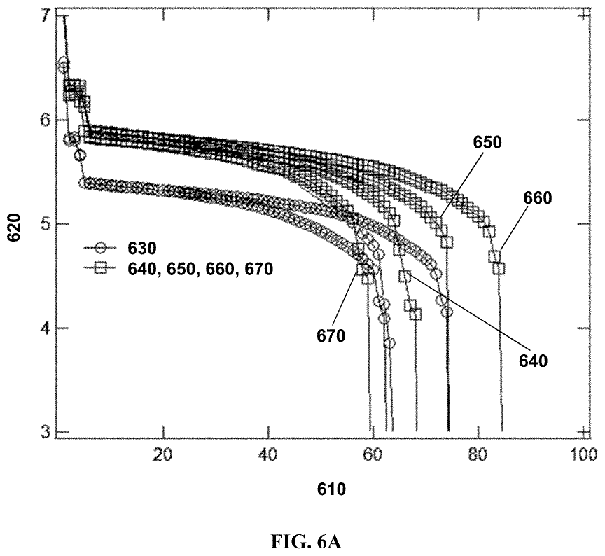

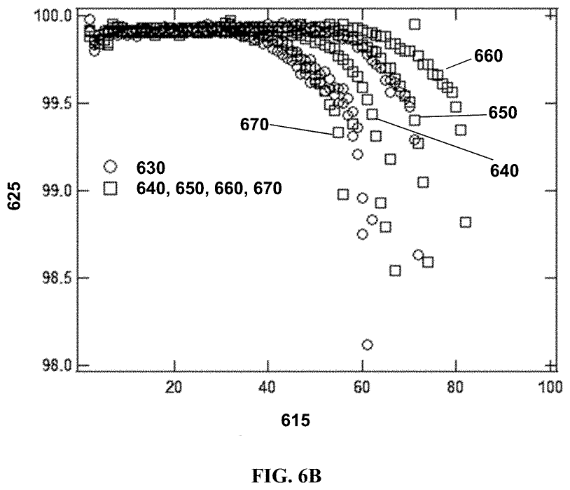

Cells 2, 3, 5, and 6 and Control Cell A were cycled as described above under basic cycling conditions. The results are shown in FIGS. 6A and 6B. In FIG. 6A, the x-axis (610) is cycle number, while discharge capacity / charge capacity (mAh) is shown on the y-axis (620) for Control Cell A (630) (run in triplicate), Cell 2 (640), Cell 3 (650), Cell 5 (660), and Cell 6 (670). In FIG. 6B, the x-axis (615) is cycle number, while Coulombic efficiency is shown on the y-axis ( 625) for Control Cell A (630) (run in triplicate), Cell 2 (640), Cell 3 (650), Cell 5 (660), and Cell 6 (670).

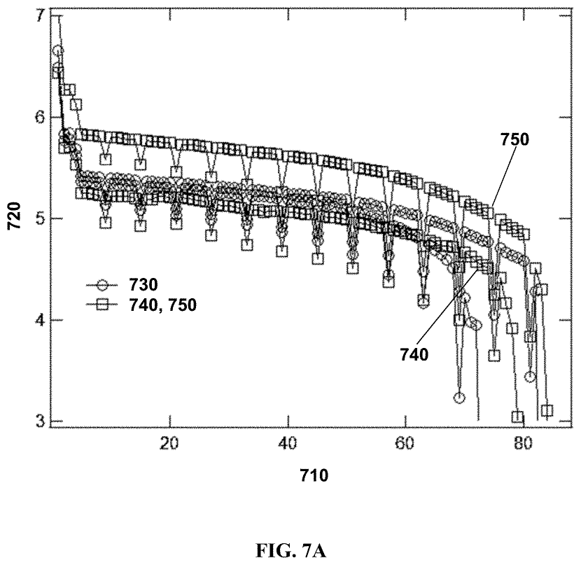

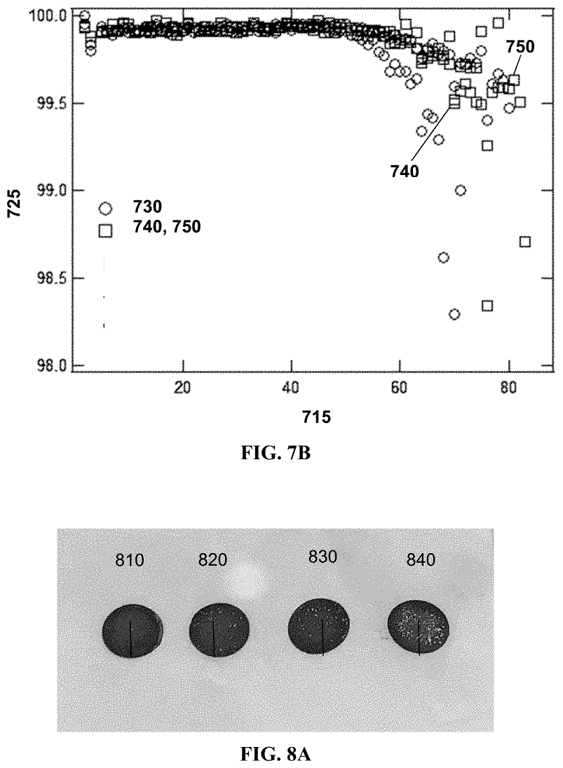

Cells 1 and 4 and Control Cell A were cycled as described above under fast charge conditions. The results are shown in FIGS. 7A and 7B. In FIG. 7A, the x-axis (710) is cycle number, while discharge capacity/charge capacity (mAh) is shown on the y-axis (720) for Control Cell A (730) (run in triplicate), Cell 1 (740), and Cell 4 (750). In FIG. 7B, the x-axis (715) is cycle number, while Coulombic efficiency is shown on the y-axis (725) for Control Cell A (730) (run in triplicate), Cell 1 (740), and Cell 4 (750).

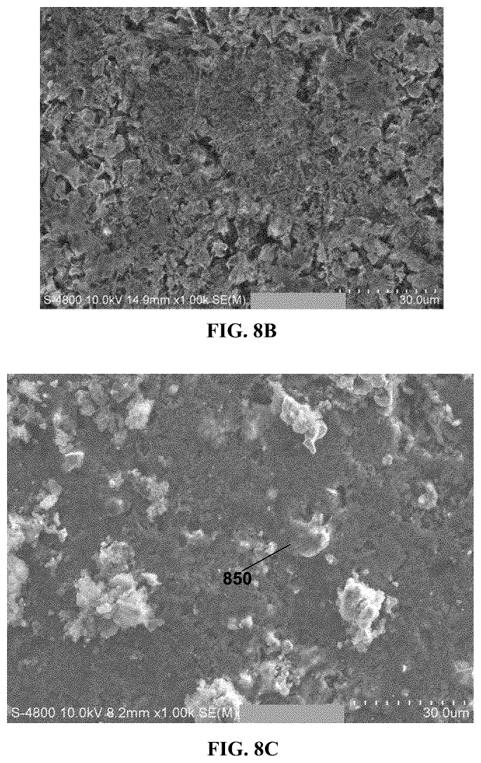

FIG. 8A is a photographic image of anodes from Control Cell A (810), Cell 2 (820), Cell 3 (830), and Cell 6 (840) after basic cycling conditions and the SEI layer formed thereon. The anode of Cell 6 show the LLZO particles (white particles) embedded in the lithium metal SEI. FIGS. 8B and 8C are SEM images of the anode surface of Control Cell A and Cell 6, respectively. FIG. 8D also show the LLZO particles (850) embedded in the lithium metal SEI.

### Example 3

The following anodes were prepared as described above with varying alumina particle loadings as shown below in Table 2.

TABLE 2

| Anode | Alumina Loading |
|---|---|
| 7 | 3.25 mg/cm² |
| 8 | 5.51 mg/cm² |
| 9 | 3.96 mg/cm² |
| 10 | 5.25 mg/cm² |

Cells 7-10 were each prepared with respective Anodes 7-10 and a cathode, a separator, and an electrolyte as described above. Control Cell A was prepared with the control anode in Example 1 and a cathode, a separator, and an electrolyte as described above.

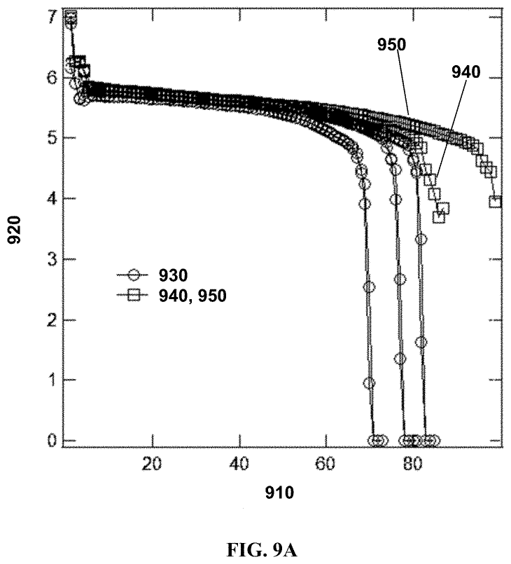

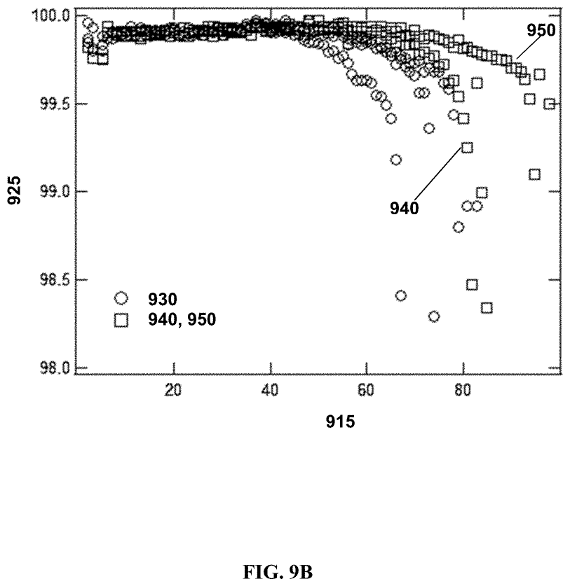

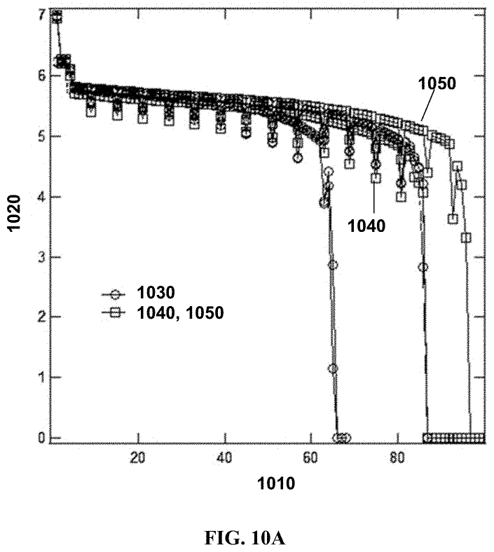

Cells 7 and 8 and Control Cell A were cycled as described above under basic cycle conditions. The results are shown in FIGS. 9A and 9B. In FIG. 9A, the x-axis (910) is cycle number, while discharge capacity/charge capacity (mAh) is shown on the y-axis (920) for Control Cell A (930) (run in triplicate), Cell 7 (940), and Cell 8 (950). In FIG. 9B, the x-axis (915) is cycle number, while Coulombic efficiency is shown on the y-axis (925) for Control Cell A (930) (run in triplicate), Cell 7 ( 940), and Cell 8 (950).

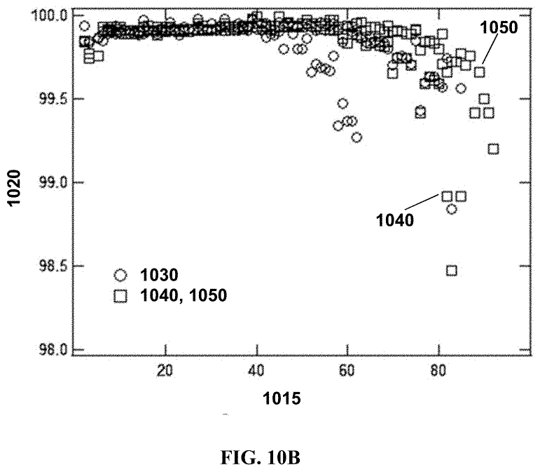

Cells 9 and 10 and Control Cell A were cycled as described above under fast charge conditions. The results are shown in FIGS. 10A and 10B. In FIG. 10A, the x-axis (1010) is cycle number, while discharge capacity/charge capacity (mAh) is shown on the y-axis (1020) for Control Cell A (1030) (run in triplicate), Cell 9 (1040), and Cell 10 (1050). In FIG. 10B, the x-axis (1015) is cycle number, while Coulombic efficiency is shown on the y-axis (1025) for Control Cell A (1030) (run in triplicate), Cell 9 (1040), and Cell 10 (1050).

The foregoing description of the embodiments has been provided for purposes of illustration and description. It is not intended to be exhaustive or to limit the disclosure. Individual elements or features of a particular embodiment are generally not limited to that particular embodiment, but, where applicable, are interchangeable and can be used in a selected embodiment, even if not specifically shown or described. The same may also be varied in many ways. Such variations are not to be regarded as a departure from the disclosure, and all such modifications are intended to be included within the scope of the disclosure.

What is claimed is:

1. A lithium metal electrode comprising:
a first surface; and
ceramic particles comprising:
(i) lithium lanthanum zirconium oxide (LLZO) particles;
(ii) alumina particles;
(iii) zirconia particles; or
(iv) a combination thereof;
wherein the ceramic particles are present:
(i) as a ceramic layer adjacent to at least a portion of the first surface, wherein the ceramic layer has a thickness of about 1 μm to about 100 μm;
(ii) as embedded within the first surface; or
(iii) a combination thereof.

2. The lithium metal electrode of claim 1, wherein one or more of the following are satisfied:
(i) the LLZO particles are selected from the group consisting of: Li_{(7-3y)}Al_{y}La₃Zr₂O₁₂, where 0≤y≤⅔; Li_{7+x-3y-z}La₃₋ₓ(M)ₓ(N)_{y}Zr_{2-z}(Q)_{z}O₁₂, where M is Ca, Ba, Mg, or Sr; N is Al or (¾)Ge; Q is Ta or Nb; 0≤x≤1; 0≤y≤⅔; 0≤y≤⅔; 0≤z≤2; and 5≤(7+x−3y−z)≤7; or a combination thereof; and
(ii) the LLZO particles, the alumina particles, and the zirconia particles each have an average particle diameter of about 100 nm to about 20 μm.

3. The lithium metal electrode of claim 1, wherein one or more of the following are satisfied:
(i) the LLZO particles are present in an amount of 0.5 g/cm² to about 50 g/cm²;
(ii) the alumina particles are present in an amount of 0.4 g/cm² to about 40 g/cm²; and
(iii) the zirconia particles are present in an amount of about 0.5 g/cm² to about 50 g/cm².

4. The lithium metal electrode of claim 1, wherein a binder is present with the ceramic particles and the binder coats at least a portion of the ceramic particles.

5. The lithium metal electrode of claim 1, wherein the ceramic particles are present as embedded within the first surface

6. The lithium metal electrode of claim 1, wherein the lithium metal electrode comprises metallic lithium.

7. An electrochemical cell comprising:
a lithium metal negative electrode
a first surface; and
ceramic particles comprising:
(i) lithium lanthanum zirconium oxide (LLZO) particles;
(ii) alumina particles;
(iii) zirconia particles; or
(iv) a combination thereof;
wherein the ceramic particles are present:
(i) as a ceramic layer adjacent to at least a portion of the first surface, wherein the ceramic layer has a thickness of about 1 μm to about 100 μm;
(ii) as embedded within the first surface; or
(iii) a combination thereof;
a positive electrode comprising a second electroactive material, wherein the positive electrode is spaced apart from the lithium metal negative electrode;
a porous separator disposed between confronting surfaces of the lithium metal negative electrode and the positive electrode; and
a liquid electrolyte infiltrating one or more of: the lithium metal negative electrode, the positive electrode, and the porous separator.

8. The electrochemical cell of claim 7, wherein one or more of the following are satisfied:
(i) the LLZO particles are selected from the group consisting of: Li_{(7-3y)}Al_{y}La₃Zr₂O₁₂, where 0≤y≤⅔; Li_{7+x-3y-z}La₃₋ₓ(M)ₓ(N)_{y}Zr_{2-z}(Q)_{z}O₁₂, where M is Ca, Ba, Mg, or Sr; N is Al or (¾)Ge; Q is Ta or Nb; 0≤x≤1; 0≤y≤⅔; 0≤y≤⅔; 0≤z≤2; and 5≤(7+x−3y−z)≤7; or a combination thereof; and
(ii) the LLZO particles, the alumina particles, and the zirconia particles each have an average particle diameter of about 100 nm to about 20 μm.

9. The electrochemical cell of claim 7, wherein one or more of the following are satisfied:
(i) the LLZO particles are present in an amount of 0.5 g/cm² to about 50 g/cm²;
(ii) the alumina particles are present in an amount of 0.4 g/cm² to about 40 g/cm²; and
(iii) the zirconia particles are present in an amount of about 0.5 g/cm² to about 50 g/cm².

10. The electrochemical cell of claim 7, wherein a binder is present with the ceramic particles and the binder coats at least a portion of the ceramic particles.

11. The electrochemical cell of claim 7, wherein the ceramic particles are present as embedded within the first surface

12. The electrochemical cell of claim 7, wherein the lithium metal electrode comprises metallic lithium, and wherein the second electroactive material is selected from the group consisting of Li₍₁₊ₓ₎Mn₂O₄, where 0.1≤x≤1; LiMn₍₂₋ₓ₎NiₓO₄, where 0≤x≤0.5; LiCoO₂; Li(NiₓMn_{y}Co_{z})O₂, where 0≤x≤1, 0≤y≤1, 0≤z≤1, and x+y+z=1; LiNi_{(1-x-y)}CoₓM_{y}O₂, where 0≤x≤0.2, y≤0.2, and M is Al, Mg, or Ti; LiFePO₄, LiMn₂₋ₓFexPO₄, where 0≤x≤0.3; LiNiCoAlO₂; LiMPO₄, where M is at least one of Fe, Ni, Co, and Mn; Li(NiₓMn_{y}Co_{z}Alₚ)O₂, where 0≤x≤1, 0≤y≤1, 0≤z≤1, 0≤P≤1, x+y+z+p=1 (NCMA); LiNiMnCoO₂; Li₂FeₓM₁₋ₓPO₄, where M is Mn and/or Ni, 0≤x≤1; LiMn₂O₄; LiFeSiO₄; LiNi_{0.6}Mn_{0.2}Co_{0.2}O₂ (NMC622), LiMnO₂ (LMO), activated carbon, sulfur, and a combination thereof.

13. A method of preparing a lithium metal electrode, the method comprising:
applying ceramic particles to a first surface of the lithium metal electrode to form a ceramic layer comprising the ceramic particles, wherein the ceramic layer is adjacent to at least a portion of the first surface and has a thickness of about 1 μm to about 100 μm;
wherein the applying the ceramic particles comprises dry casting or slurry casting; and
wherein the ceramic particles comprise:
(i) lithium lanthanum zirconium oxide (LLZO);
(ii) alumina particles;
(iii) zirconia particles; or
(iv) a combination thereof.

14. The method of claim 13, wherein one or more of the following are satisfied:
(i) the LLZO particles are selected from the group consisting of: Li_{(7-3y)}Al_{y}La₃Zr₂O₁₂, where 0≤y≤⅔; Li_{7+x-3y-z}La₃₋ₓ(M)ₓ(N)_{y}Zr_{2-z}(Q)_{z}O₁₂, where M is Ca, Ba, Mg, or Sr; N is Al or (¾)Ge; Q is Ta or Nb; 0≤x≤1; 0≤y≤⅔; 0≤y≤⅔; 0≤z≤2; and 5≤(7+x−3y−z)≤7; or a combination thereof, and (ii) the LLZO particles, the alumina particles, and the zirconia particles each have an average particle diameter of about 100 nm to about 20 μm.

15. The method of claim 13, wherein one or more of the following are satisfied:
(i) the LLZO particles are present in an amount of 0.5 g/cm² to about 50 g/cm²;
(ii) the alumina particles are present in an amount of 0.4 g/cm² to about 40 g/cm²; and
(iii) the zirconia particles are present in an amount of about 0.5 g/cm² to about 50 g/cm².

16. The method of claim 13, wherein a binder is applied with the ceramic particles and the binder coats at least a portion of the ceramic particles.

17. The method of claim 13, further comprising pressing the ceramic layer to embed the ceramic particles within the first surface.

18. The method of claim 13, wherein the applying the ceramic particles is a slurry casting comprising applying a slurry to the first surface, wherein the slurry comprises a solvent and the ceramic particles.

19. The method of claim 18, further comprising drying the slurry applied to the first surface of the lithium metal negative electrode to remove the solvent.
